(19) United States
(12) Patent Application Publication
(10) Pub. No.: US 2010/0038391 A1
(43) Pub. Date: Feb. 18, 2010

(54) ALL-TERRAIN VEHICLE CARRIER AND ASSOCIATED METHODS

(76) Inventor: Bobby Gene Cumbie, Newnan, GA (US)

Correspondence Address: GEORGE R. REARDON, 3356 STATION COURT, LAWRENCVILLE, GA, 30044, US

(21) Appl. No.: 12/192,165

(22) Filed: Aug. 15, 2008

(51) Int. Cl. B60R 9/06; B65G 69/28; A47B 96/00; B65G 69/22

(52) U.S. Cl. 224/502; 108/44; 108/23; 108/143; 414/800

(57) ABSTRACT

The technology described herein provides an all-terrain vehicle (ATV) carrier assembly for loading and transporting multiple ATVs, motorcycles, and the like. A convertible, rotatable carrier assembly for loading and transporting multiple all-terrain vehicles (ATVs) includes a platform assembly upon which one or more ATV is loaded, the platform assembly being rotatable such that the one or more ATV is loaded selectively from one of a driver, passenger, and rear side of a vehicle and a trailer hitch receiver and a hitch tube disposed upon the trailer hitch receiver for connectivity with a vehicle having a rear hitch. The platform assembly is convertible and rotatable, enabling loading and transportation of multiple ATVs without the need for a trailer.

### FIELD OF THE INVENTION

The technology described herein relates generally to suspended cargo racks and carriers for automobile vehicles. More specifically, this technology relates to a convertible, rotatable all-terrain vehicle carrier to transport multiple all-terrain vehicles, motorcycles, and the like without a trailer.

### BACKGROUND OF THE INVENTION

Cargo racks and carriers that are suspended from the rear of a vehicle generally are utilized to provide additional storage space for the vehicle. Such racks and carriers can be utilized to transport luggage, tools, bicycles, and other items on the rear exterior of a vehicle.

Related patents known in the art include the following. U.S. Pat. No. 6,948,732, issued to Amacker on Sep. 27, 2005, discloses convertible cargo rack. U.S. Pat. No. 5,881,937, issued to Sadler on Mar. 16, 1999, discloses a movable frame assembly.

The foregoing patent and other information reflect the state of the art of which the inventor is aware and are tendered with a view toward discharging the inventor's acknowledged duty of candor in disclosing information that may be pertinent to the patentability of the technology described herein. It is respectfully stipulated, however, that the foregoing patent and other information do not teach or render obvious, singly or when considered in combination, the inventor's claimed invention.

### BRIEF SUMMARY OF THE INVENTION

In various exemplary embodiments, the technology described herein provides an all-terrain vehicle (ATV) carrier assembly for loading and transporting multiple ATVs, motorcycles, and the like.

In one exemplary embodiment, the technology described herein provides a convertible, rotatable carrier assembly for loading and transporting multiple all-terrain vehicles (ATVs). The carrier assembly includes a platform assembly upon which one or more ATV is loaded, the platform assembly being rotatable such that the one or more ATV is loaded selectively from one of a driver, passenger, and rear side of a vehicle and a trailer hitch receiver and a hitch tube disposed upon the trailer hitch receiver for connectivity with a vehicle having a rear hitch. The platform assembly is convertible and rotatable, enabling loading and transportation of multiple ATVs without the need for a trailer.

The carrier assembly also includes a sliding tube, the sliding tube slidably disposed about the trailer hitch receiver and integrally connected to the platform assembly to selectively slide the platform assembly closer to, and farther from, the rear of the vehicle and a locking mechanism disposed upon the sliding tube with which to lock in place the sliding tube at a desired location along the trailer hitch receiver to maintain a stable position of the platform assembly relative to the vehicle.

The carrier assembly also includes a platform frame and a platform pivot frame assembly having a swivel bearing and a pivot quick release pin. The platform frame is disposed upon the swivel bearing and is rotated selectively by an operator and locked into a desired position of rotation in the platform pivot frame assembly.

The carrier assembly also includes an incline adjustment assembly to selectively raise and lower the platform assembly along an incline to aid in the loading and unloading of an ATV, the incline adjustment assembly having an incline quick release pin to lock the platform in position a desired angle of incline.

The carrier assembly also includes a plurality of extensible ramps hingedly connected to the platform assembly to aid in the loading and unloading of an ATV to and from the platform assembly, at least one of which is moveable and slidable for relocation upon the platform assembly. The carrier assembly also includes a motorcycle platform to receive a two-wheeled vehicle, wherein one of the at least one moveable and slidable extensible ramps is configured for placement with the motorcycle platform for loading and unloading a motorcycle.

The carrier assembly further includes one or more ground support assemblies with castors to provide support to the platform assembly during loading and unloading. The one or more ground support assemblies can include a front ground support assembly with two castors and a rear ground support assembly with two castors. The carrier assembly also includes a jacking assembly having an at least one swivel trailer jack disposed upon the front ground support assembly and configured to selectively raise and lower the carrier assembly.

The carrier assembly also includes a stiffening wedge assembly comprising an at least one housing and an at least one stiffening wedge disposed in the housing and selectively utilized between the trailer hitch receiver and hitch tube to provide improved stability to the carrier assembly.

The carrier assembly also includes a hitch ball and tow assembly disposed upon a rear of the carrier assembly to provide for the attachment of a light trailer to the carrier assembly. The carrier assembly further includes a light assembly having two tail lights, the light assembly disposed upon the trailer hitch receiver and configured to selectively illuminate in a rearward direction from the carrier assembly while in use on a vehicle.

In another exemplary embodiment, the technology described herein provides a method for loading and transporting multiple all-terrain vehicles (ATVs). The method includes utilizing a convertible, rotatable carrier assembly, selectively rotating the carrier assembly to one of a driver, passenger, and rear side of the vehicle, extending the plurality of extensible ramps, loading a first ATV onto the carrier assembly, and returning the plurality of extensible ramps, thereby enabling the loading and transporting of multiple ATVs without the need for a trailer.

The method also can include moving the first ATV into a back of the vehicle after loading the first ATV onto the carrier assembly, loading a second ATV onto the carrier assembly for transport on the carrier assembly, and returning the plurality of extensible ramps.

The method also can include selectively sliding the platform assembly closer to, and farther from, the rear of the vehicle for aid in loading and unloading and locking the sliding tube in place utilizing the locking means to prevent the sliding tube from moving once it is in a desired position.

The method also can include selectively rotating the carrier assembly to one of a driver, passenger, and rear side of the vehicle and locking the carrier assembly into place with the pivot quick release pin. The method also includes selectively adjusting the incline of the platform assembly to aid in the loading and unloading of an ATV. The method also includes moving the first ATV into a back of the vehicle after loading the first ATV onto the carrier assembly, loading a motorcycle onto the carrier assembly for transport on the carrier assembly, and returning the plurality of extensible ramps. The method also includes selectively raising and lowering the platform assembly with the jacking assembly. The method also includes towing the light trailer behind the carrier assembly.

Advantageously, this technology provides a convertible and rotatable carrier assembly that enables the loading, unloading, and transporting of multiple ATVs without the need for a trailer. Advantageously, this technology also provides a carrier assembly that is loadable from multiple sides of a vehicle.

There has thus been outlined, rather broadly, the more important features of the technology in order that the detailed description thereof that follows may be better understood, and in order that the present contribution to the art may be better appreciated. There are additional features of the technology that will be described hereinafter and which will form the subject matter of the claims appended hereto. In this respect, before explaining at least one embodiment of the technology in detail, it is to be understood that the invention is not limited in its application to the details of construction and to the arrangements of the components set forth in the following description or illustrated in the drawings. The technology described herein is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the technology described herein.

Further objects and advantages of the technology described herein will be apparent from the following detailed description of a presently preferred embodiment which is illustrated schematically in the accompanying drawings.

### BRIEF DESCRIPTION OF THE DRAWINGS

The technology described herein is illustrated with reference to the various drawings, in which like reference numbers denote like device components and/or method steps, respectively, and in which:

FIG. 1 is a perspective diagram of a convertible, rotatable all-terrain vehicle (ATV) carrier, illustrating, in particular, a single ATV loaded onto the carrier, according to an embodiment of the technology;

FIG. 2 is a side planar view of the ATV carrier;

FIG. 3 is a perspective view of the ATV carrier;

FIG. 4 is a perspective view of the ATV carrier, illustrating, in particular, the rotatability of the platform assembly;

FIG. 5 is a perspective view of the ATV carrier, illustrating, in particular, the extensibility of the ramps, according to an embodiment of the technology;

FIG. 6 is a side view of the ATV carrier, illustrating, in particular, the extensibility of the ramps;

FIG. 7 is a perspective view of the ATV carrier, illustrating, in particular, the loading of an ATV upon the extended ramps, according to an embodiment of the technology;

FIG. 8 is a perspective view of the ATV carrier, illustrating, in particular, the loading of an ATV upon the extended ramps, when the ATV carrier is rotated such that the ATV is loaded from a driver side, according to an embodiment of the technology;

FIG. 9 is a perspective view of the ATV carrier, illustrating, in particular, the storability of the ground support assembly, according to an embodiment of the technology;

FIG. 10 is a perspective view of the ATV carrier, illustrating, in particular, an ATV loaded by the ATV carrier into a truck bed, the carrier now available for a second ATV to be loaded or for transport as shown with a single ATV; and

FIG. 11 is a perspective view of the ATV carrier, illustrating, in particular, the ATV ready for transport after loading from the driver side.

### DETAILED DESCRIPTION OF THE INVENTION

Before describing the disclosed embodiments of this technology in detail, it is to be understood that the technology is not limited in its application to the details of the particular arrangement shown here since the technology described is capable of other embodiments. Also, the terminology used herein is for the purpose of description and not of limitation.

In various exemplary embodiments, the technology described herein provides an all-terrain vehicle (ATV) carrier assembly for loading and transporting multiple ATVs, motorcycles, and the like.

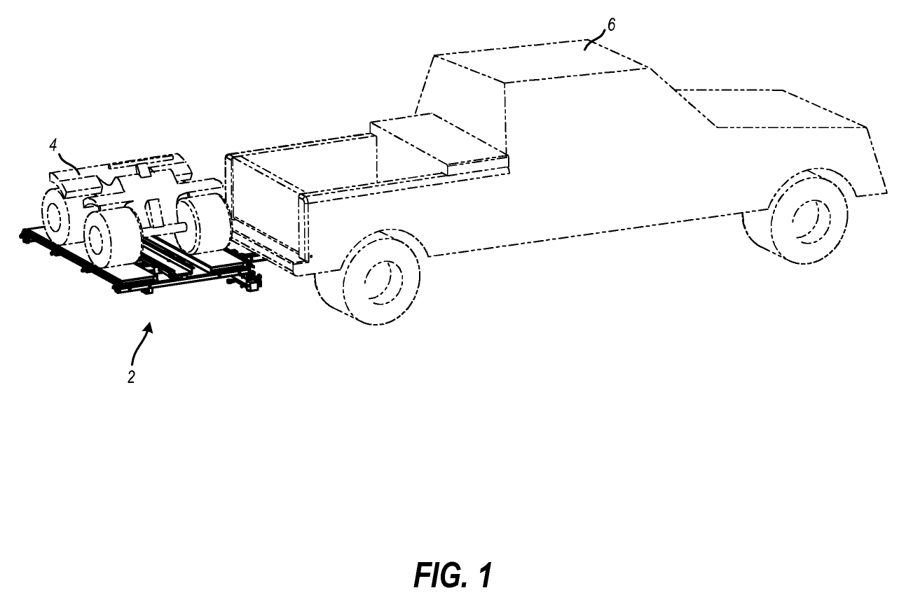

Referring now to FIG. 1, a carrier assembly 2 is shown. The carrier assembly 2 selectively is mounted to a vehicle 6 having a rear hitch, such as, for example, a truck, sport-utility vehicle (SUV), or the like. The carrier assembly 2 is convertible and rotatable, allowing for rotation of up to 180 degrees and for loading and unloading an ATV 4 or the like, from a driver, passenger, and rear side, for example, of a vehicle 6. The carrier assembly 2 is configured for loading, unloading, and transporting multiple all-terrain vehicles (ATVs) 4, including, for example, but not limited to, quad-runners, four-wheelers, three-wheelers, two-wheeled bikes, etc., without the use of a trailer towed behind the vehicle 6. In transporting an ATV 4, the carrier assembly 2 can be utilized such that the ATV 4 has its wheels perpendicular to the direction of the wheels of the vehicle 6 for transport.

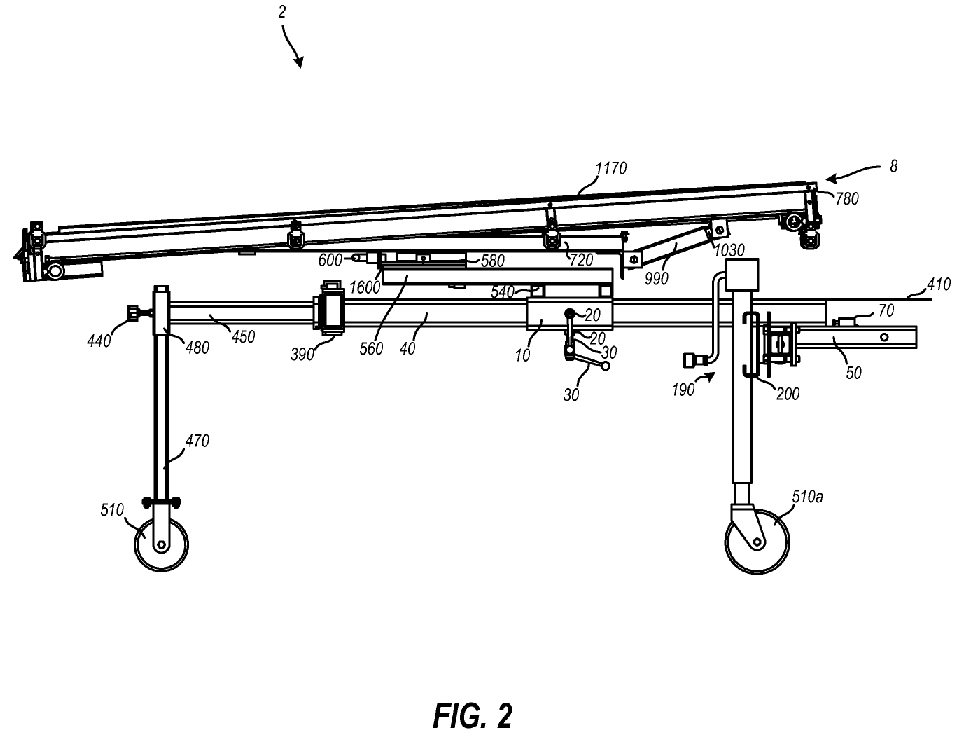

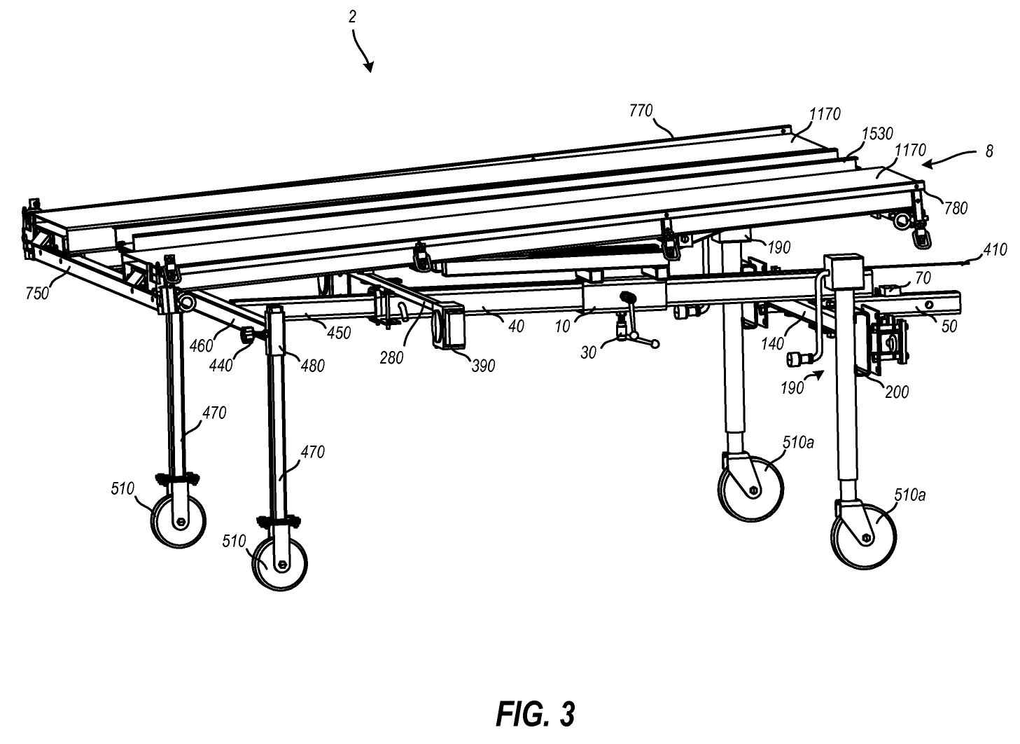

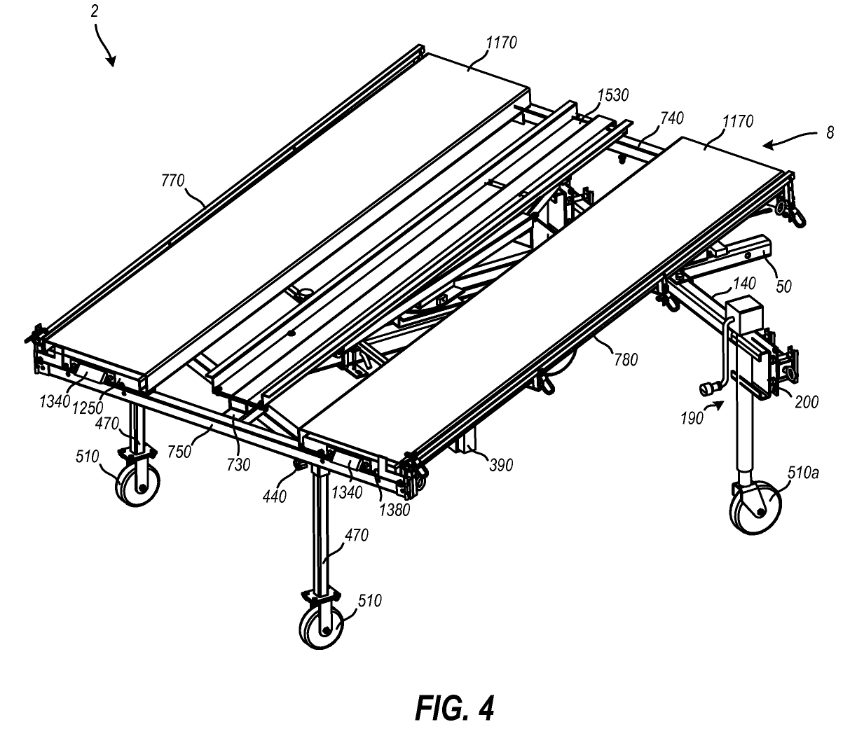

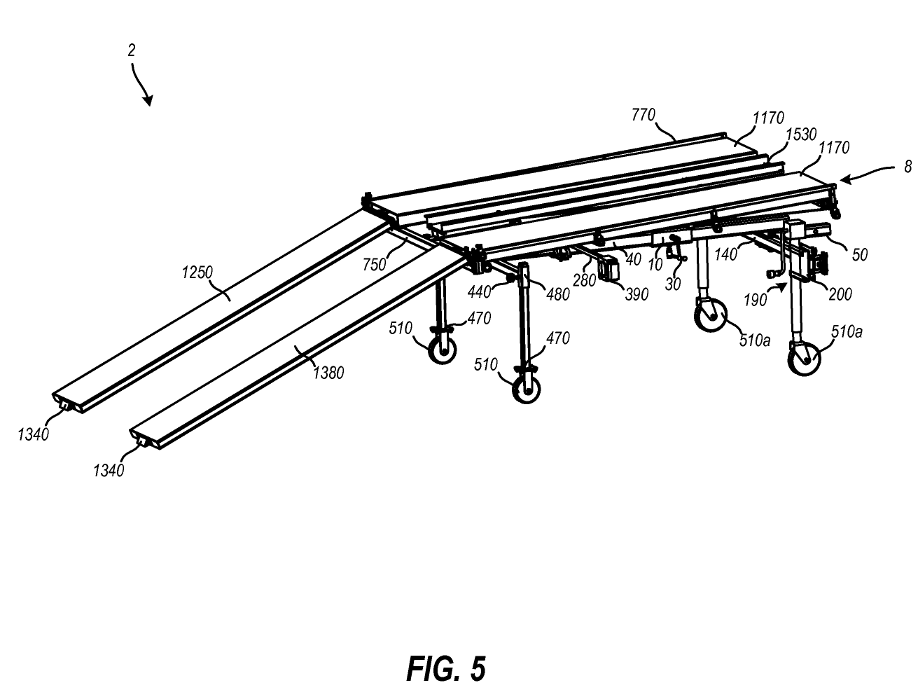

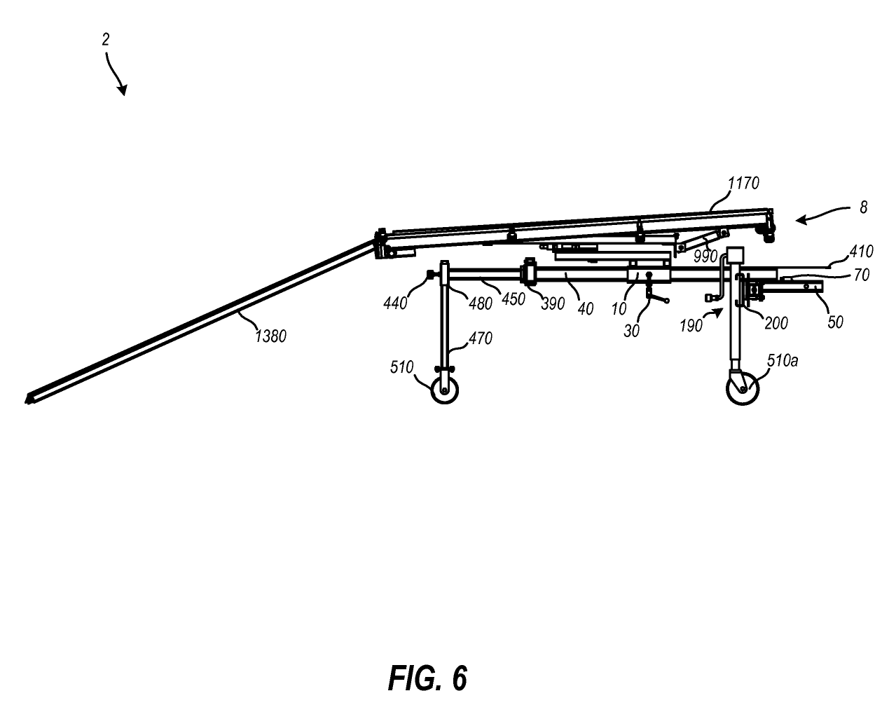

Referring now to FIGS. 2, 3, 4, 5, and 6, the carrier assembly 2 is shown in various views. The carrier assembly 2 includes a trailer hitch receiver 40 and a hitch tube 50 disposed upon the trailer hitch receiver 40 for connectivity with a vehicle 6 having a rear hitch. The trailer hitch receiver 40 and the hitch tube 50 can be, for example, composite steel tubing, or the like. The convertible, rotatable carrier assembly 2 for loading and transporting multiple ATVs includes a platform assembly 8 upon which one or more ATV 4 is loaded. The platform assembly 8 is rotatable such that the one or more ATV 4 is loaded selectively from one of a driver, passenger, and rear side position of a vehicle 6, along a 180 degree rotation path of the carrier assembly 2.

The platform assembly 8 includes extensible ramps 1250, 1380 hingedly connected to the platform assembly 8 to aid in the loading and unloading of an ATV 4 to and from the platform assembly. At least one of the extensible ramps 1250, 1380 is moveable and slidable for relocation upon the platform assembly. As shown in the figures, the extensible ramps include a fixed ramp 1250 and a moveable ramp 1380; however, both ramps can be fixed or moveable as desired in the configuration of the carrier assembly 2. Each ramp 1250, 1380 has a ramp handle 1340 with which to pull the ramp out of the platform shell 1170. Each ramp 1250, 1380 slides in and out of a platform shell 1170. In at least one embodiment, the fixed ramp 1250 and the moveable ramp 1380 are aluminum, thus providing a durable, yet lightweight, set of ramps to the platform assembly 8.

The extensible ramps 1250, 1380 can include handles 1350 by which the ramps 1250, 1380 can be grasped by an operator and pulled out from the platform shells 1170. The handles 1350 can include flanges to aid the operator in grasping the ramps 1250, 1380. The extensible ramps 1250, 1380 slide out of the platform shells 1170 and can include hinges, stop hinges, hinge mounts, magnets, magnetic contacts, connecting angles, stop plates, fasteners, and hinge pins, to pivot about for lowering the extensible ramps 1250, 1380 toward the ground surface. The extensible ramps 1250, 1380 can include stop plates such that the ramps 1250, 1380 are not extended too far before lowering toward the ground surface. The extensible ramps 1250, 1380 also can include ramp braces for support and guidance.

The platform assembly 8 includes a motorcycle platform 1530. The motorcycle platform 1530 is configured to receive a two-wheeled vehicle, or the like. The moveable ramp 1380 is moved from its location and placed adjacent to the motorcycle platform 1530 for the loading and unloading of a motorcycle (not shown). In at least one embodiment, the motorcycle platform 1530 is aluminum, thus providing a durable, yet lightweight, structure upon which to load and/or transport a motorcycle, or the like. The motorcycle platform 1530 includes mount holes and flanges to aid the placement of the wheels of the motorcycle.

The platform assembly 8 includes a main beam 720, a main support beam 730, a front support beam 740, rear support beam 750, left side rail 770, and right side rail 780, upon which the platform shell 1170, ramps 1250, 1380, and motorcycle platform 1530 are disposed. The beams 720, 730, 740, 750 and rails 770, 780 provide structural support to the platform assembly 8 and can be made from composite steel tubing, for example. Additional tabs, extensions, pins, locking pin support plates, locking pins, fasteners, eyebolts, tie-down rings, containment locks, and caps, for example, can be utilized to manufacture the platform assembly 8 and join various components one to another. A multiplicity of holes can be bored into the main beam 720, main support beam 730, front support beam 740, rear support beam 750, left side rail 770, and right side rail 780 for attachment to and connectivity with other components of the carrier assembly 2.

The platform assembly 8 includes a platform pivot frame assembly having a pivot platform 580, a swivel bearing 1600, and a pivot quick release pin 600. This assembly enables an operator selectively to rotate the platform assembly 8 to a desired position of rotation about the vehicle and lock the platform assembly 8 into position with the pivot quick release pin 600. For example, an operator can rotate the platform assembly 8 to a driver, passenger, or rear side of the vehicle and lock the platform assembly 8 into place.

The platform assembly 8 can include various support structures such as, for example, platform support tubing 560 and cross support tubing 540. The swivel bearing 1600 includes, for example, a thin Teflon® sheet. The swivel bearing 1600 has a hole in the center to receive a fastener and platform pivot shaft for attachment to the platform pivot frame assembly. The platform pivot frame assembly is mounted upon the slide tubing 10 to slide about the trailer hitch receiver 40.

The platform assembly 8 includes an incline adjustment assembly to selectively raise and lower the platform assembly 8 along an incline to aid in the loading and unloading of an ATV. The incline adjustment assembly includes an incline adjustment outer tube 990 and a position tube 1030. The incline adjustment assembly includes an incline quick release pin disposed upon the incline adjustment outer tube 990 and passing through a hole within the position tube 1030 to lock the platform assembly 8 in position at a desired angle of incline. The position tube 1030 includes a multiplicity of holes in which to receive a quick release pin at varied locations. The incline adjustment assembly provides for the platform assembly 8 to be raised and lowered as desired to an appropriate, desired angle to the vehicle 6 for loading and unloading.

The carrier assembly 2 includes a sliding tube 10 disposed about the trailer hitch receiver 40 and integrally connected to the platform assembly 8 to selectively slide the platform assembly 8 closer to, and farther from, the rear of the vehicle 6. The sliding tube 10 and the trailer hitch receiver 40 are, for example, composite steel tubing. The carrier assembly 2 includes a locking mechanism having a clamp nut 20 and handle 30, such as, for example, a die-cast zinc adjustable handle with a knob, disposed upon the sliding tube 10 with which to lock in place the sliding tube 10 at a desired location along the trailer hitch receiver 40 in order to maintain a stable position of the platform assembly 8 relative to the vehicle 6. A clamp nut 20 and handle 30 are shown on a side and bottom of the sliding tube 10.

The carrier assembly 2 also includes one or more ground support assemblies to provide support to the platform assembly 8 during loading and unloading. A rear ground support assembly includes rear support tubes 470 having casters 510. The rear support tubes 470 are joined by leg cross support tube 460 having a leg support tube 480 at each end through which a rear support tube 470 is placed and raised or lowered as desired. Each rear support tube 470 is locked into place at a desired height by tightening each knob 440. The rear ground support assembly is joined to assembly connection tube 450 and slides into trailer hitch receiver 40. A front ground support assembly includes a front ground support beam 140. Attached to the front ground support beam 140 with clamps 200 are two swivel trailer jack assemblies 190, one on each side, and swivel casters 510a on each of the swivel trailer jack assemblies 190 to raise and lower carrier assembly 2 as necessary for mounting and dismounting the carrier assembly 2 from a vehicle 6.

The carrier assembly 2 also includes a light assembly. The light assembly includes a right tail light 390 and a left tail light 400. The right tail light 390 and the left tail light 400 are mounted upon light support tube 280. The right tail light 390 and the left tail light 400 are configured to selectively illuminate in a rearward direction from the carrier assembly 2 while in use on a vehicle 6. Trailer wires 410 provide for electrical connectivity between the right and left tail lights 390, 400 of the carrier assembly 2 and the vehicle 6.

The carrier assembly 2 also includes a hitch ball (not shown) and tow assembly disposed upon a rear of the carrier assembly 2 to provide for the attachment of a light trailer to the carrier assembly 2. In an optional configuration, when the rear ground support assembly with rear support tubes 470 having casters 510, leg cross support tube 460 having a leg support tube 480 at each end, and assembly connection tube 450 is removed from the trailer hitch receiver 40, the trailer hitch receiver 40 is configured to receive a hitch or hitch ball to pull a light trailer behind the carrier assembly 2.

The carrier assembly 2 also includes a stiffening wedge assembly comprising an at least one housing 70 and an at least one stiffening wedge disposed in the housing 70 and selectively utilized between the trailer hitch receiver 40 and hitch tube 50 to provide improved stability to the carrier assembly 2.

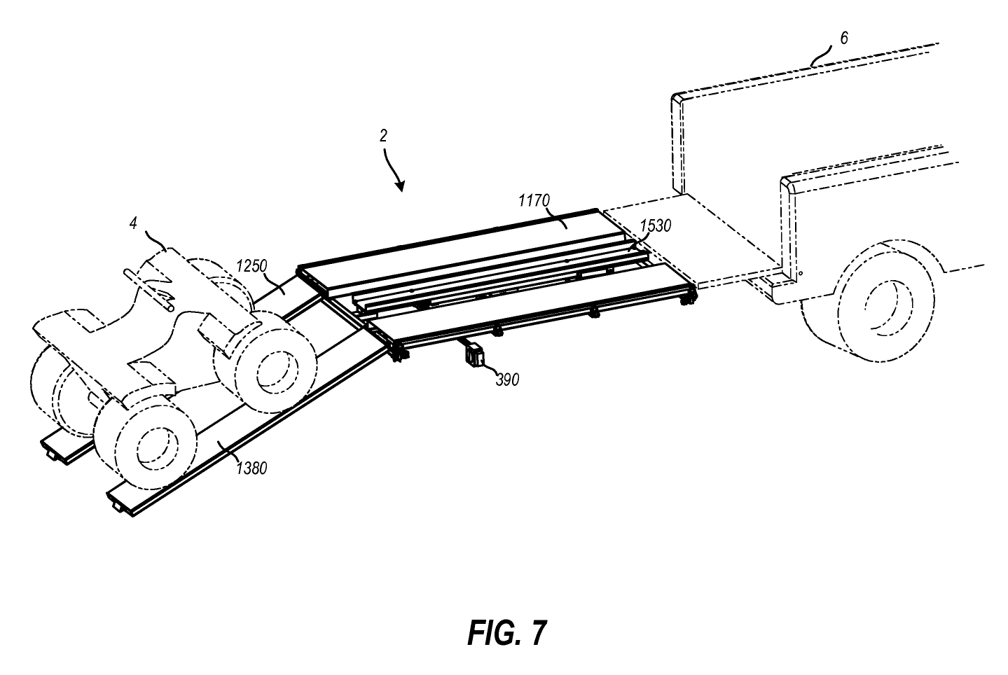

Referring now to FIG. 7, the loading of an ATV 4 upon the extended ramps 1250, 1380 is shown. Both the front and rear ground support assemblies previously shown in earlier figures are utilized to bring the carrier assembly to a vehicle 6. They are not required to support the ATV 4 as is loaded upon the carrier assembly 2 and into the vehicle 6 as is depicted in FIG. 7. The ATV 4 is driven or rolled up the ramps 1250, 1380 to the platform shells 1170 where it can be tied down for transport, or where it can be further driven or rolled into the bed of the vehicle 6.

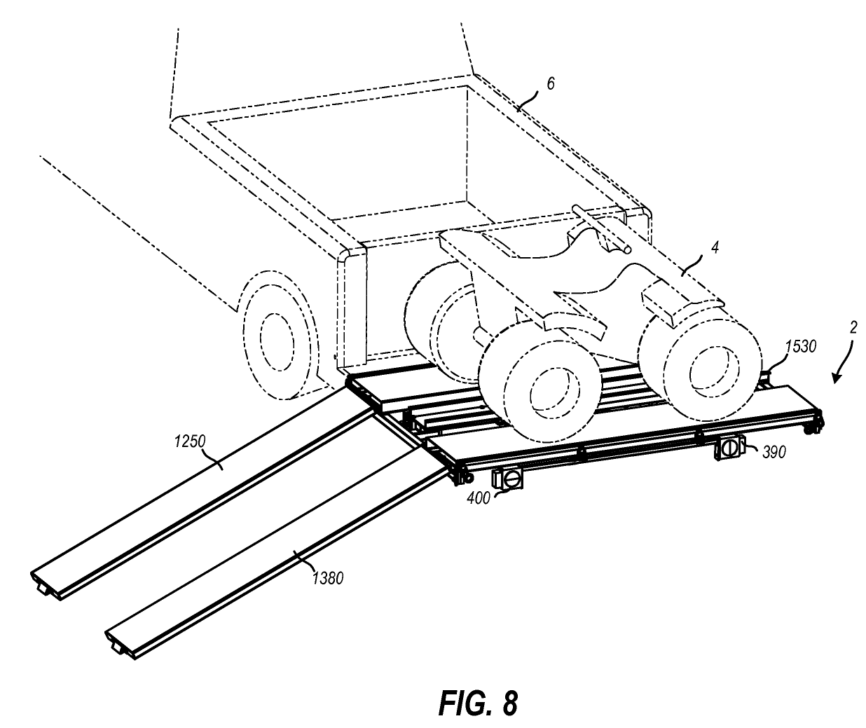

Referring now to FIG. 8, the loading of an ATV 4 upon the extended ramps 1250, 1380, when the carrier assembly is rotated such that the ATV 4 is loaded from a driver side, is shown. The ATV 4 is loaded in similar fashion as that shown and described with FIG. 7. However, prior to loading, the carrier assembly 2 is rotated 90 degrees in a direction toward the driver's side of the vehicle 6, such that the ATV 4 can be loaded and transported from this side.

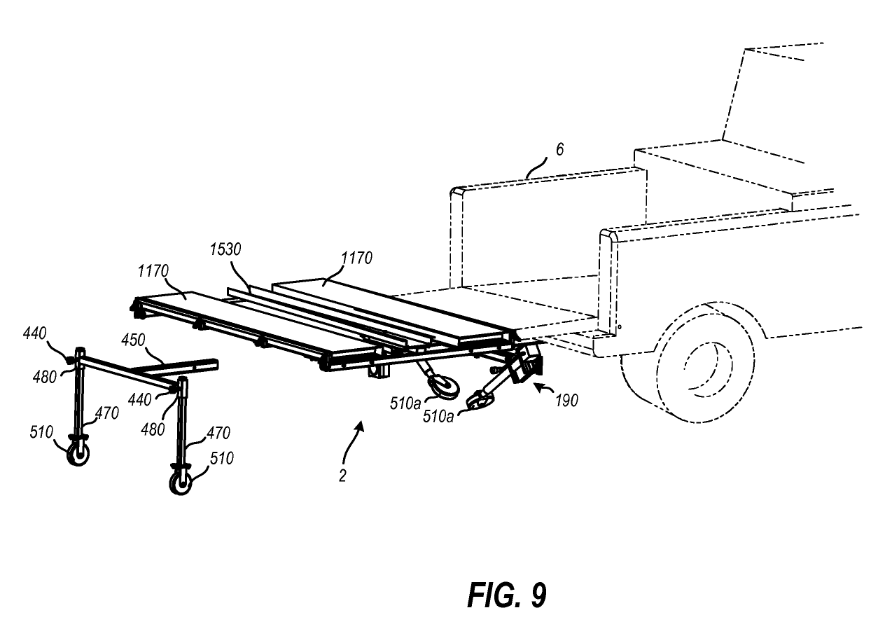

Referring now to FIG. 9, the storability of the ground support assemblies is shown. The ATV 4 is loaded as shown in FIG. 8. Upon successful transport of the carrier assembly to the vehicle 6, the ground support assemblies are dismounted and/or retracted. The rear ground assembly, having rear support tubes 470 with casters 510, leg cross support tube 460 having a leg support tube 480 with a tightening knob 440 at each end, and assembly connection tube 450, is removed from trailer hitch receiver 40.

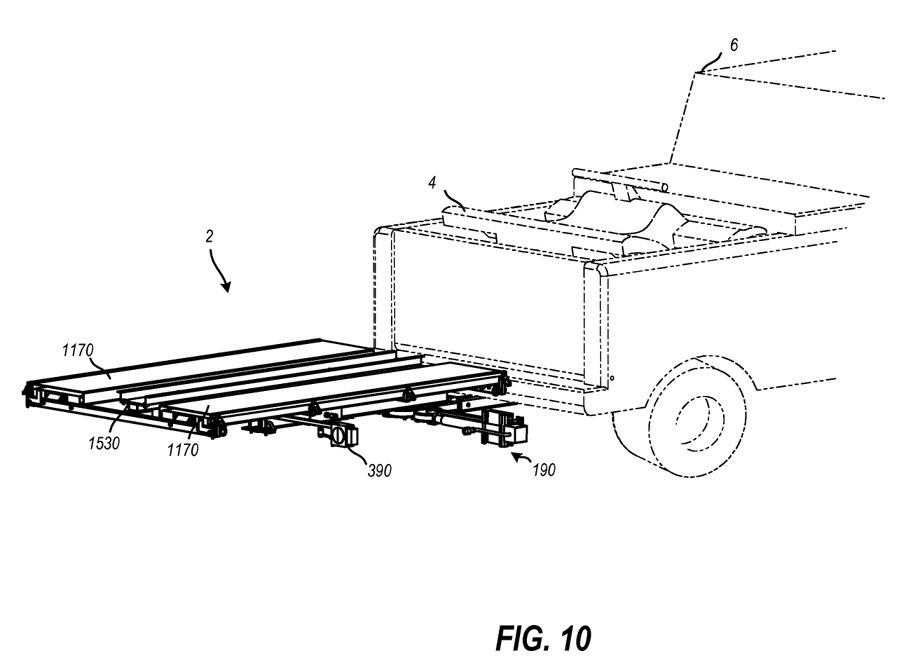

Referring now to FIG. 10, an ATV 4 loaded by the carrier assembly 2 is placed into a truck bed of vehicle 6, the carrier assembly 2 now available for a second ATV 4 to be loaded or for transport as shown with a single ATV 4, is shown. The ground support assemblies are dismounted and/or retracted.

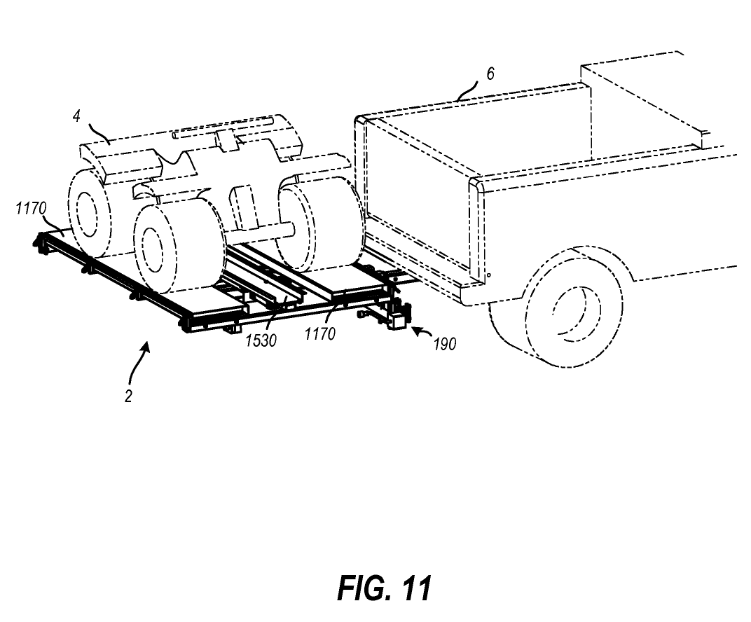

Referring now to FIG. 11, the ATV 4 is shown ready for transport after loading from the driver side. In an alternative to the arrangement shown in FIG. 10, the ATV 4 is transported on the carrier assembly 2 rather than being placed into the bed of vehicle 6. In this arrangement, the ATV 4 is shown after having been loaded from the driver side of vehicle 6.

In operation, the carrier assembly 2 is assembled, for example, with at least the following steps: sliding tube 10 is placed over trailer hitch receiver 40 midway; handles 30 are threaded and side clamp nuts 20 are welded to sliding tube 10; trailer hitch receiver 40 is welded to sliding tube 10; a front ground support beam mount is attached to hitch tube 50; stiffening wedges are attached to stiffening wedge housing 70; stiffening wedge housing 70 is welded to hitch tube 50; front ground support beam 140 is installed to the front ground support beam mount; swivel trailer jack assemblies 190 are installed using trailer jack clamp 200; trailer lights 390, 400 and trailer wires 410 are installed; ground support assemblies are installed; pivot platform 580 is welded to platform support tubing; incline assembly is installed; main beam 720 is welded to front support beam 740 and rear support beam 750; slide positioning tube 1030 is placed within incline adjustment outer tube 990; attaching pivot platform 580 to swivel bearing 1600; attaching platform shell 1170 to rear support beam 750 and front support beam 740; and utilizing various additional tabs, extensions, pins, locking pin support plates, locking pins, fasteners, eyebolts, tie-down rings, containment locks, and caps, for example, can be utilized to manufacture the platform assembly 8 and join various components one to another.

In operation, the carrier assembly 2 is utilized example, with at least the following steps: to connect the carrier assembly 2 to the rear of a vehicle 6, roll and align the carrier assembly 2 directly behind the vehicle 6 having a hitch; rotate platform assembly 8 to the desired position for additional loading and unloading; utilize the swivel jacks 190 and knobs 440 to adjust the carrier assembly 2 to slide the hitch tube 50 into the vehicle 6 having a hitch; utilize the stiffening wedge housing 70 and associated stiffening wedges to make connectivity of the trailer hitch receiver 40 to the hitch tube 50; roll the swivel trailer jack assemblies 190 off of the ground and fold into a stowed position; adjust platform shells 1170 to the tailgate of vehicle 6; drive ATVs or motorcycles up ramps 1250, 1380 and into bed of vehicle 6; and slide ramps 1250, 1380 back into platform shells 1170; utilizing pivot quick release pin 600.

Although this technology has been illustrated and described herein with reference to preferred embodiments and specific examples thereof, it will be readily apparent to those of ordinary skill in the art that other embodiments and examples can perform similar functions and/or achieve like results. For example, this game and its associated methods can be embodied in an electronic format, played on a personal computer, the Internet, or the like. All such equivalent embodiments and examples are within the spirit and scope of the invention and are intended to be covered by the following claims.

What is claimed is:

1. A convertible, rotatable carrier assembly for loading and transporting multiple all-terrain vehicles (ATVs), the carrier assembly comprising:
a platform assembly upon which one or more ATV is loaded, the platform assembly being rotatable such that the one or more ATV is loaded selectively from one of a driver, passenger, and rear side of a vehicle; and
a trailer hitch receiver and a hitch tube disposed upon the trailer hitch receiver for connectivity with a vehicle having a rear hitch;
wherein the platform assembly is convertible and rotatable, enabling loading and transportation of multiple ATVs without the need for a trailer.

2. The carrier assembly of claim 1, further comprising:
a sliding tube, the sliding tube slidably disposed about the trailer hitch receiver and integrally connected to the platform assembly to selectively slide the platform assembly closer to, and farther from, the rear of the vehicle; and
a locking mechanism disposed upon the sliding tube with which to lock in place the sliding tube at a desired location along the trailer hitch receiver to maintain a stable position of the platform assembly relative to the vehicle.

3. The carrier assembly of claim 1, the platform assembly further comprising:
a platform frame;
and a platform pivot frame assembly having a swivel bearing and a pivot quick release pin;
wherein the platform frame is disposed upon the swivel bearing and is rotated selectively by an operator and locked into a desired position of rotation in the platform pivot frame assembly.

4. The carrier assembly of claim 1, further comprising:
an incline adjustment assembly to selectively raise and lower the platform assembly along an incline to aid in the loading and unloading of an ATV, the incline adjustment assembly having an incline quick release pin to lock the platform in position a desired angle of incline.

5. The carrier assembly of claim 1, the platform assembly further comprising:
a plurality of extensible ramps hingedly connected to the platform assembly to aid in the loading and unloading of an ATV to and from the platform assembly, at least one of which is moveable and slidable for relocation upon the platform assembly.

6. The carrier assembly of claim 5, further comprising:
a motorcycle platform to receive a two-wheeled vehicle, wherein one of the at least one moveable and slidable extensible ramps is configured for placement with the motorcycle platform for loading and unloading a motorcycle.

7. The carrier assembly of claim 1, further comprising:
one or more ground support assemblies with castors to provide support to the platform assembly during loading and unloading.

8. The carrier assembly of claim 7, further comprising:
a front ground support assembly with two castors; and
a rear ground support assembly with two castors.

9. The carrier assembly of claim 8, further comprising:
a jacking assembly having an at least one swivel trailer jack disposed upon the front ground support assembly and configured to selectively raise and lower the carrier assembly.

10. The carrier assembly of claim 1, further comprising:
a stiffening wedge assembly comprising an at least one housing and an at least one stiffening wedge disposed in the housing and selectively utilized between the trailer hitch receiver and hitch tube to provide improved stability to the carrier assembly.

11. The carrier assembly of claim 1, further comprising:
a hitch ball and tow assembly disposed upon a rear of the carrier assembly to provide for the attachment of a light trailer to the carrier assembly.

12. The carrier assembly of claim 1, further comprising:
a light assembly having two tail lights, the light assembly disposed upon the trailer hitch receiver and configured to selectively illuminate in a rearward direction from the carrier assembly while in use on a vehicle.

13. A method for loading and transporting multiple all-terrain vehicles (ATVs), the method comprising:
utilizing a convertible, rotatable carrier assembly comprising a platform assembly upon which one or more ATV is loaded, the platform assembly being rotatable such that the one or more ATV is loaded selectively from one of a driver, passenger, and rear side of a vehicle and a trailer hitch receiver; a hitch tube disposed upon the trailer hitch receiver for connectivity with a vehicle having a rear hitch; and a plurality of extensible ramps hingedly connected to the platform assembly to aid in the loading and unloading of an ATV to and from the platform assembly, at least one of which is moveable and slidable for relocation upon the platform assembly;
selectively rotating the carrier assembly to one of a driver, passenger, and rear side of the vehicle;
extending the plurality of extensible ramps;
loading a first ATV onto the carrier assembly; and
returning the plurality of extensible ramps;
thereby enabling the loading and transporting of multiple ATVs without the need for a trailer.

14. The method of claim 13, further comprising:
moving the first ATV into a back of the vehicle after loading the first ATV onto the carrier assembly;
loading a second ATV onto the carrier assembly for transport on the carrier assembly; and
returning the plurality of extensible ramps.

15. The method of claim 13, further comprising:
utilizing a convertible, rotatable carrier assembly further comprising a sliding tube, the sliding tube slidably disposed about the trailer hitch receiver and integrally connected to the platform assembly to selectively slide the platform assembly closer to, and farther from, the rear of the vehicle; and a locking mechanism disposed upon the sliding tube with which to lock in place the sliding tube at a desired location along the trailer hitch receiver to maintain a stable position of the platform assembly relative to the vehicle;
selectively sliding the platform assembly closer to, and farther from, the rear of the vehicle for aid in loading and unloading; and
locking the sliding tube in place utilizing the locking means to prevent the sliding tube from moving once it is in a desired position.

16. The method of claim 13, further comprising:
utilizing a convertible, rotatable carrier assembly further comprising a platform frame; and a platform pivot frame assembly having a swivel bearing and a pivot quick release pin; wherein the platform frame is disposed upon the swivel bearing and is rotated selectively by an operator and locked into a desired position of rotation in the platform pivot frame assembly;
selectively rotating the carrier assembly to one of a driver, passenger, and rear side of the vehicle; and
locking the carrier assembly into place with the pivot quick release pin.

17. The method of claim 13, further comprising:
utilizing a convertible, rotatable carrier assembly further comprising an incline adjustment assembly to selectively raise and lower the platform assembly along an incline to aid in the loading and unloading of an ATV, the incline adjustment assembly having an incline quick release pin to lock the platform in position a desired angle of incline; and
selectively adjusting the incline of the platform assembly to aid in the loading and unloading of an ATV.

18. The method of claim 13, further comprising:
utilizing a convertible, rotatable carrier assembly further comprising a motorcycle platform to receive a two-wheeled vehicle, wherein one of the at least one moveable and slidable extensible ramps is configured for placement with the motorcycle platform for loading and unloading a motorcycle.
moving the first ATV into a back of the vehicle after loading the first ATV onto the carrier assembly;
loading a motorcycle onto the carrier assembly for transport on the carrier assembly; and
returning the plurality of extensible ramps.

19. The method of claim 13, further comprising:
utilizing a convertible, rotatable carrier assembly further comprising a front ground support assembly with two castors and a rear ground support assembly with two castors to provide support to the platform assembly during loading and unloading; and a jacking assembly having an at least one swivel trailer jack disposed upon the front ground support assembly and configured to selectively raise and lower the carrier assembly; and
selectively raising and lowering the platform assembly with the jacking assembly.

20. The method of claim 13, further comprising:
utilizing a convertible, rotatable carrier assembly further comprising a hitch ball and tow assembly disposed upon a rear of the carrier assembly to provide for the attachment of a light trailer to the carrier assembly; and
towing the light trailer behind the carrier assembly.
